(19) United States
(12) Patent Application Publication
(10) Pub. No.: US 2025/0068467 A1
(43) Pub. Date: Feb. 27, 2025

(54) CONTIGUOUS MEMORY ALLOCATION DEVICE AND CONTIGUOUS MEMORY ALLOCATION METHOD

(71) Applicant: REALTEK SEMICONDUCTOR CORPORATION, Hsinchu (TW)

(72) Inventors: Yi-Kuan WU, Hsinchu (TW); Hsiang-Wei SUNG, Hsinchu (TW); Meng-Sin WU, Hsinchu (TW); Sheng-Kai HUNG, Hsinchu (TW); Tsai-Chin CHENG, Hsinchu (TW)

(21) Appl. No.: 18/813,080

(22) Filed: Aug. 23, 2024

Related U.S. Application Data
(60) Provisional application No. 63/534,419, filed on Aug. 24, 2023.

(30) Foreign Application Priority Data
Apr. 30, 2024 (TW) 113116249

(51) Int. Cl. G06F 9/50

(52) U.S. Cl. CPC G06F 9/5016; G06F 9/5044

(57) ABSTRACT

A contiguous memory allocation device includes a memory and a processor. The memory is configured to store at least one command. The processor is configured to read the at least one command to execute following steps: calculating a page thrashing value of the memory; determining a corresponding relation between the page thrashing value and a predetermined thrashing value; and deciding whether to lend a contiguous memory according to the corresponding relation.

### BACKGROUND OF THE INVENTION

### 1. Field of the Invention

The present disclosure relates to a contiguous memory allocation device and a contiguous memory allocation method, especially to a contiguous memory allocation device and a contiguous memory allocation method that decide whether to lend a contiguous memory according to a page thrashing value.

### 2. Description of Related Art

The contiguous memory allocator (CMA) can provide contiguous memory to users who need it. If the above-mentioned contiguous memory is unused, the contiguous memory allocator can lend the contiguous memory to other users.

Linux operating system tends to lend contiguous memory to other users to enhance efficiency of memory usage. However, when there is a demand for video playback, due to contiguous memory being borrowed by other users, Linux operating system needs to reclaim contiguous memory first, which results in slower startup speed of videos.

Google's Android common kernels (ACK) will exclude those related to file systems from borrowing contiguous memory, which limit the efficiency of memory usage. However, when there is a demand for video playback, Google's Android common kernels have additional contiguous memory to accelerate the startup speed of videos. As a result, it can be understood that regardless of the technology adopted, it is impossible to simultaneously optimize memory usage efficiency and the startup speed of video playback.

### SUMMARY OF THE INVENTION

In some aspects, an object of the present disclosure is to, but not limited to, provides a contiguous memory allocation device and a contiguous memory allocation method that makes an improvement to the prior art.

An embodiment of a contiguous memory allocation device of the present disclosure includes a memory and a processor. The memory is configured to store at least one command. The processor is configured to read the at least one command to execute following steps: calculating a page thrashing value of the memory; determining a corresponding relation between the page thrashing value and a predetermined thrashing value; and deciding whether to lend a contiguous memory according to the corresponding relation.

An embodiment of a contiguous memory allocation method of the present disclosure is executed by a processor reading at least one command stored in a memory, and the contiguous memory allocation method includes following steps: calculating a page thrashing value of the memory; determining a corresponding relation between the page thrashing value and a predetermined thrashing value; and deciding whether to lend a contiguous memory according to the corresponding relation.

Technical features of some embodiments of the present disclosure make an improvement to the prior art. The contiguous memory allocation device and the contiguous memory allocation method of the present disclosure can decide whether to lend the contiguous memory according to the page thrashing value. When the page thrashing value is larger, it represents that the memory usage is high. At this time, the contiguous memory can be lent. In addition, when the page thrashing value is smaller, it represents that the memory usage is low. At this time, the contiguous memory is prohibited from lending to accelerate the startup speed of videos. In view of the above, the present disclosure achieves both of high memory usage efficiency and fast startup speed of video playback.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a contiguous memory allocation device of the present disclosure.

FIG. 2 shows an embodiment of a flow diagram of a contiguous memory allocation method of the present disclosure.

FIG. 3 shows an embodiment of a flow diagram of a contiguous memory allocation method of the present disclosure.

FIG. 4 shows an embodiment of an operation diagram of a contiguous memory allocation device of the present disclosure.

FIG. 5 shows an embodiment of an operation diagram of a contiguous memory allocation device of the present disclosure.

FIG. 6 shows an embodiment of an operation diagram of a contiguous memory allocation device of the present disclosure.

FIG. 7 shows an embodiment of an operation diagram of a contiguous memory allocation device of the present disclosure.

FIG. 8 shows an embodiment of an operation diagram of a contiguous memory allocation device of the present disclosure.

FIG. 9 shows an embodiment of an operation diagram of a contiguous memory allocation device of the present disclosure.

### DETAILED DESCRIPTION OF THE PREFERRED EMBODIMENTS

To improve the problem that regardless of the technology adopted for lending contiguous memory, it is impossible to achieve both of memory usage efficiency and startup speed of video playback, the present disclosure provides a contiguous memory allocation device and a contiguous memory allocation method, which will be explained in detail as shown below.

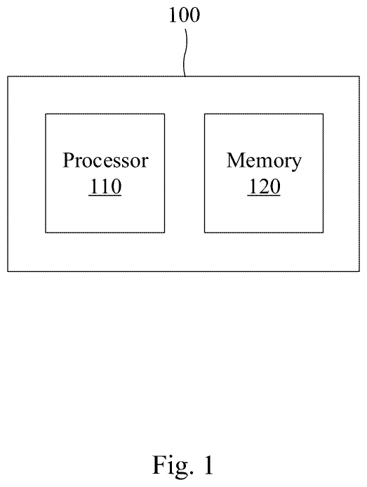

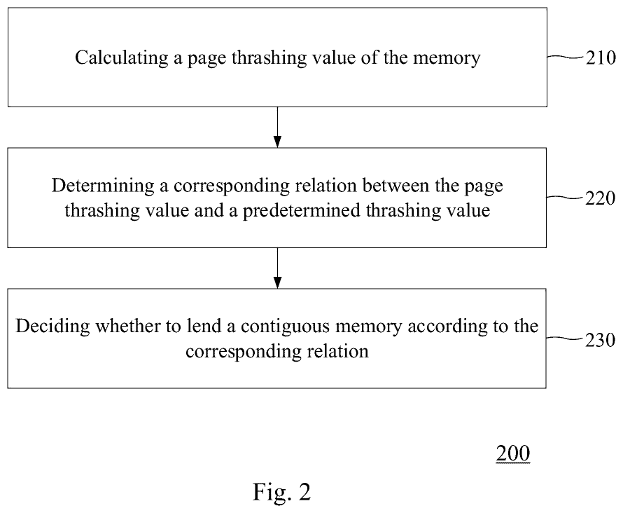

FIG. 1 shows an embodiment of a contiguous memory allocation device 100 of the present disclosure. As shown in the figure, the contiguous memory allocation device 100 includes a processor 110 and a memory 120. The memory 120 is configured to store at least one command. The processor 110 is configured to read the at least one command to execute contiguous memory allocation operations. For facilitating the understanding of the operations of the contiguous memory allocation device 100, reference is now made to FIG. 2. FIG. 2 shows an embodiment of a flow diagram of a contiguous memory allocation method 200 of the present disclosure.

Referring to FIG. 1 and FIG. 2, in the step 210, calculating a page thrashing value of the memory. For example, the processor 110 is utilized to calculate the page thrashing value of the memory 120. In some embodiments, the processor 110 is utilized to calculate the page thrashing value according to a current file page number which is frequently used, a previous file page number which is frequently used, and a total file page number which is previously used, and the formula is as shown below:

$${Value}_{thash} = \frac{( {file}_{work} - {file}_{init} ) \times 100}{( {file}_{base} + 1 )} \% \qquad formula 1$$

As shown in formula 1, Valueₜₕₐₛₕ is the page thrashing value (presented in a percentage % manner), file_{work} is the number of file pages being currently and frequently read and reclaimed per second, fileᵢₙᵢₜ is the number of file pages being frequently read and reclaimed in the previous second, and file_{base} is the total number of file pages in the previous second. The total number of file pages in the previous second may include the number of inactive file pages in the system and the number of active file pages in the system. Formula 1 calculates the file page number difference between the current file page number which is frequently used file_{work} and the previous file page number which is frequently used fileᵢₙᵢₜ. Subsequently, a percentage (%) of the file page number difference and the total file page number which is previously used file_{base} is calculated to serve as the page thrashing value Valueₜₕₐₛₕ.

If the page thrashing value Valueₜₕₐₛₕ calculated by the formula 1 is low, it represents that most of the file pages are retained in the memory page cache, it represents that applications can read file pages quickly, and it represents that the overall memory demand of the current system is not high.

If the page thrashing value Valueₜₕₐₛₕ calculated by the formula 1 is high, it represents that the current memory pressure is high. File pages are frequently reclaimed and read. If an application fails to read a reclaimed file page and has to reload it into the memory, it results in delays, and it also represents that the overall memory demand of the current system is very high.

In the step 220, determining a corresponding relation between the page thrashing value and a predetermined thrashing value. For example, the predetermined thrashing value is proportional to the memory pressure of the memory 120. In other words, when the memory pressure of the memory 120 is larger, the predetermined thrashing value is set higher correspondingly. After the predetermined thrashing value is set, the present disclosure can utilize the processor 110 to determine the corresponding relation of the page thrashing value and the predetermined thrashing value.

In some embodiments, the predetermined thrashing value ranges from 1 percentage (%) to 200 percentage (%). In some embodiments, the predetermined thrashing value ranges from 5 percentage (%) to 150 percentage (%). In some embodiments, the predetermined thrashing value ranges from 10 percentage (%) to 100 percentage (%). In some embodiments, the predetermined thrashing value can be approximately 10 percentage (%). In some embodiments, the predetermined thrashing value can be approximately 20 percentage (%), 30 percentage (%), 40 percentage (%), or 50 percentage (%).

In the step 230, deciding whether to lend a contiguous memory according to the corresponding relation. For example, the processor 110 is utilized to decide whether to lend the contiguous memory according to the corresponding relation between the page thrashing value and the predetermined thrashing value. Since the present disclosure can decide whether to lend the contiguous memory according to the according to the state of the memory 120, the present disclosure can solve the problem that it impossible to achieve both of the memory usage efficiency and the startup speed of video playback in the prior art.

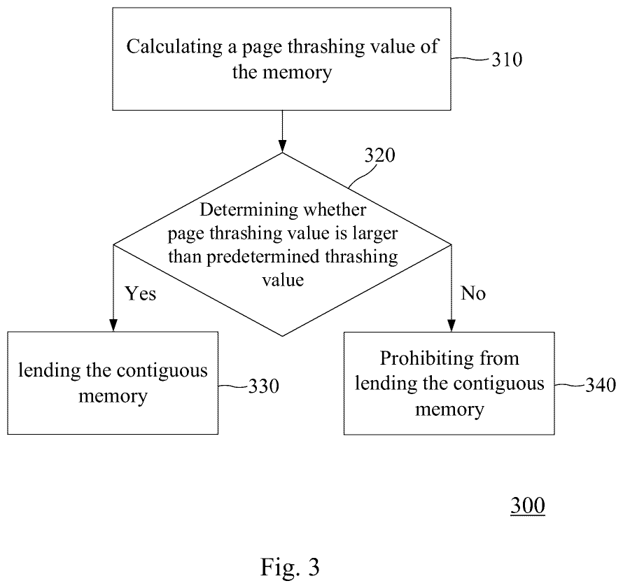

In some embodiments, referring to FIG. 3, FIG. 3 shows an embodiment of a flow diagram of a contiguous memory allocation method 300 of the present disclosure. The step 310 is similar to the step 210 in FIG. 2, and therefore the description regarding the step 310 is omitted herein. In the step 320, determining whether the page thrashing value is larger than the predetermined thrashing value. For example, the processor 110 can determine whether the page thrashing value is larger than the predetermined thrashing value. If the page thrashing value is larger than the predetermined thrashing value, it represents that the overall memory demand of the current system is high. The step 330 is therefore executed to lend the contiguous memory. If the page thrashing value is not larger than the predetermined thrashing value, it represents that the overall memory demand of the current system is not high. The step 340 is therefore executed to prohibit from lending the contiguous memory.

The present disclosure can lend the contiguous memory according to the page thrashing value when the overall memory demand of the current system is high, thereby enhancing the memory usage efficiency. In addition, the present disclosure can prohibit from lending the contiguous memory according to the page thrashing value when the overall memory demand of the current system is not high, thereby enhancing the startup speed of video playback. Therefore, the present disclosure can solve the problem that it is impossible to achieve both of the memory usage efficiency and the startup speed of video playback in the prior art.

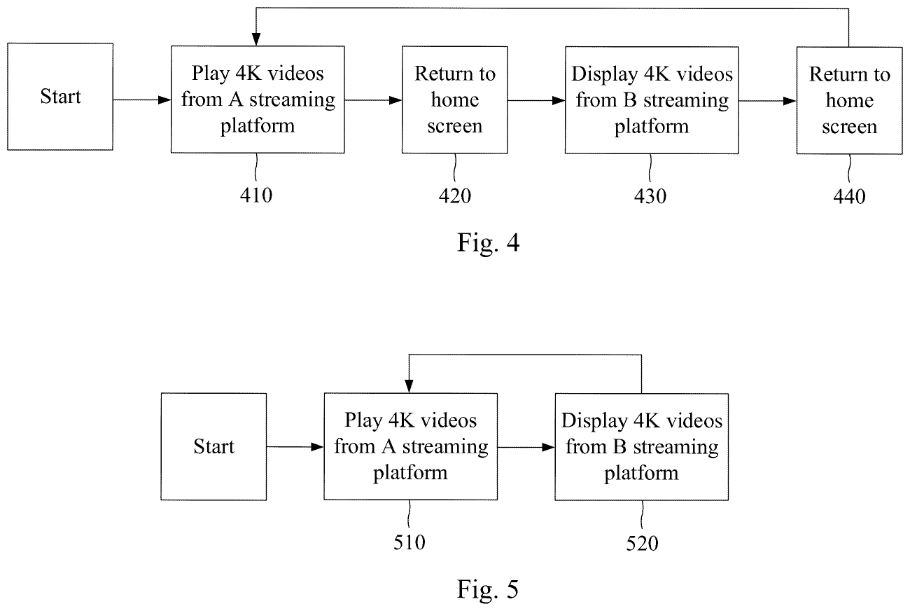

FIG. 4 shows an embodiment of an operation diagram of the contiguous memory allocation device 100 of the present disclosure. As shown in the figure, in the operation 410, Linux, Android common kernels (ACK), and the present disclosure all play 4K videos from A streaming platform first. Subsequently, in the operation 420, return to home screen (e.g., execute back to home launcher). Next, in the operation 430, all three methods display 4K videos from B streaming platform. Subsequently, in the operation 440, return to home screen. In some embodiments, A streaming platform can be YouTube, and B streaming platform can be Netflix. However, the present disclosure is not limited to the above-mentioned embodiments, and it is provided for illustrative purposes to demonstrate one implementation of the present disclosure. In other embodiments, other suitable streaming platform (e.g., Disney+) can be adopted according to the actual requirements.

Please refer to the test results in Table 1. In the operation of FIG. 4, if Linux is set to 0.00% as a baseline, the startup speeds of video displaying of Android common kernel and the present disclosure are faster by 26.68% and 24.34%, respectively. As a result, the present disclosure can indeed enhance the startup speed of video displaying.

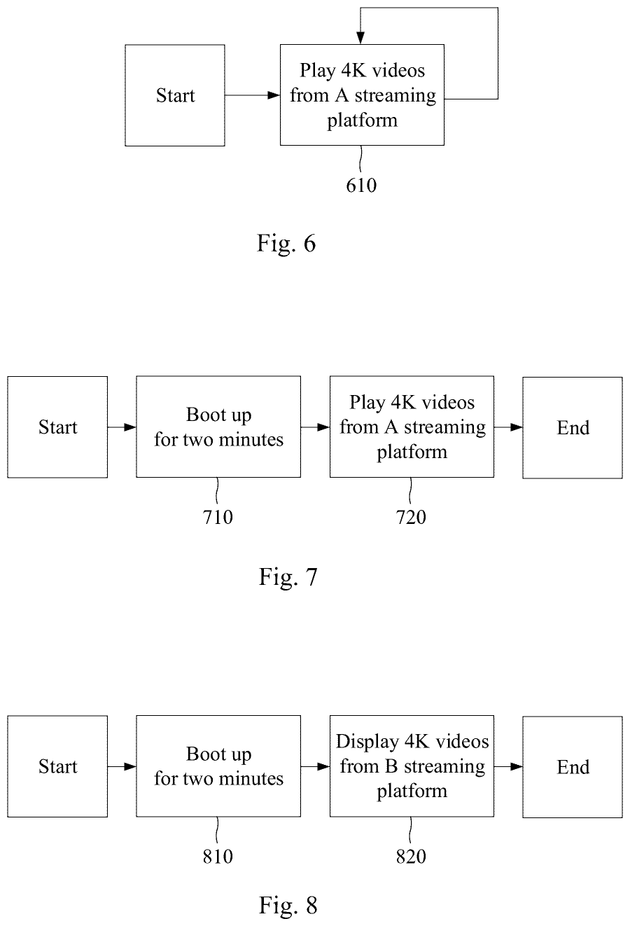

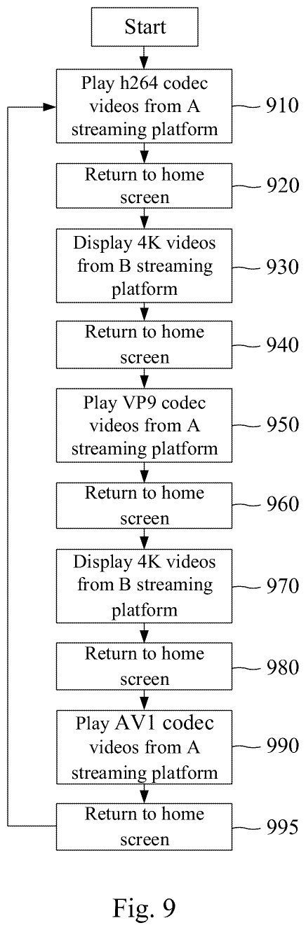

TABLE 1
test results:

| | | Android | Present |
|---|---|---|---|
| Item | Linux | common kernel | disclosure |
| Third-party software | 19.21% | 0.00% | 22.17% |
| Operation in FIG. 4 | 0.00% | −26.68% | −24.34% |
| Operation in FIG. 5 | 0.00% | −24.18% | −16.52% |
| Operation in FIG. 6 | 0.00% | −52.66% | −51.44% |
| Operation in FIG. 7 | 0.00% | −13.75% | −14.35% |
| Operation in FIG. 8 | 0.00% | −26.83% | −27.95% |
| Operation in FIG. 9 | 0.00% | −24.52% | −24.06% |

In addition, as shown in Table 1, when the third-party software (e.g., memory benchmark) is utilized to test Linux, Android common kernel, and the present disclosure, if Android common kernel is set to 0.00% as a baseline, the performances of Linux and the present disclosure are enhanced by 19.21% and 22.17%, respectively. As a result, the present disclosure can indeed enhance the memory performance/efficiency.

FIG. 5 shows an embodiment of an operation diagram of the contiguous memory allocation device 100 of the present disclosure. As shown in the figure, in the operation 510, Linux, Android common kernel, and the present disclosure all display 4K videos from A streaming platform first. Subsequently, in the operation 520, all three methods directly display 4K videos from B streaming platform. For example, when all three methods display 4K videos from A streaming platform, users can directly press the shortcut key of B streaming platform to directly display 4K videos from B streaming platform. Please refer to the test results in Table 1, if Linux is set to 0.00% as a baseline, the startup speed of video displaying of Android common kernel and the present disclosure are faster by 24.18% and 16.52%, respectively. As a result, the present disclosure can indeed enhance the startup speed of video displaying.

FIG. 6 shows an embodiment of an operation diagram of the contiguous memory allocation device 100 of the present disclosure. As shown in the figure, in the operation 610, Linux, Android common kernel, and the present disclosure all display the first episode of 4K videos from A streaming platform. Subsequently, after finishing the first episode, all three methods continue to display the second episode of 4K videos from A streaming platform. Please refer to the test results in Table 1. If Linux is set to 0.00% as a baseline, the startup speed of video displaying of Android common kernel and the present disclosure are faster by 52.66% and 51.44%, respectively. As a result, the present disclosure can indeed enhance the startup speed of video displaying.

FIG. 7 and FIG. 8 show embodiments of operation diagrams of the contiguous memory allocation device 100 of the present disclosure. Please also refer to FIG. 7 and FIG. 8. In the operations 710, 810, Linux, Android common kernel, and the present disclosure all boot up for two minutes. After two minutes, in the operations 720, 820, all three methods display 4K videos from A streaming platform, or all three methods display 4K videos from B streaming platform. Please refer to the test results in Table 1. If Linux is set to 0.00% as a baseline, the startup speeds of video displaying of Android common kernel and the present disclosure in FIG. 7 are faster by 13.75% and 14.35%, respectively. The startup speeds of video displaying of Android common kernel and the present disclosure in FIG. 8 are faster by 26.83% and 27.95%, respectively. As a result, the present disclosure can indeed enhance the startup speed of video displaying.

FIG. 9 shows an embodiment of an operation diagram of the contiguous memory allocation device 100 of the present disclosure. As shown in the figure, in the operation 910, Linux, Android common kernel, and the present disclosure all display h264 codec videos from A streaming platform. Subsequently, in the operation 920, return to home screen. Next, in the operation 930, all three methods also display 4K videos from B streaming platform. Next, in the operation 940, return to home screen. In addition, in the operation 950, all three methods also display VP9 codec videos from A streaming platform. Subsequently, in the operation 960, return to home screen. Next, in the operation 970, all three methods also display 4K videos from B streaming platform. Subsequently, in the operation 980, return to home screen. In addition, in the operation 990, all three methods also display AVI codec videos from A streaming platform. Subsequently, in the operation 995, return to home screen. Please refer to the test results in Table 1. If Linux is set to 0.00% as a baseline, the startup speeds of video displaying of Android common kernel and the present disclosure are faster by 24.52% and 24.06%, respectively. As a result, the present disclosure can indeed enhance the startup speed of video displaying.

It is noted that the present disclosure is not limited to the embodiments as shown in FIG. 1 to FIG. 9, which are merely examples for illustrating the implementations of the present disclosure, and the scope of the present disclosure shall be defined on the bases of the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The contiguous memory allocation device and the contiguous memory allocation method of the present disclosure can decide whether to lend the contiguous memory according to the page thrashing value. When the page thrashing value is larger, it represents that the memory usage is high. At this time, the contiguous memory can be lent. In addition, when the page thrashing value is smaller, it represents that the memory usage is low. At this time, the contiguous memory is prohibited from lending to accelerate the startup speed of videos. In view of the above, the present disclosure can achieve both of high memory usage efficiency and fast startup speed of video playback.

It is noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A contiguous memory allocation device, comprising:
a memory, configured to store at least one command; and
a processor, configured to read the at least one command to execute following steps:
calculating a page thrashing value of the memory;
determining a corresponding relation between the page thrashing value and a predetermined thrashing value; and
deciding whether to lend a contiguous memory according to the corresponding relation.

2. The contiguous memory allocation device of claim 1, wherein the processor is further configured to read the at least one command to execute following steps:
determining whether the page thrashing value is larger than the predetermined thrashing value; and
if the page thrashing value is larger than the predetermined thrashing value, lending the contiguous memory.

3. The contiguous memory allocation device of claim 1, wherein the processor is further configured to read the at least one command to execute following steps:
determining whether the page thrashing value is larger than the predetermined thrashing value; and
if the page thrashing value is not larger than the predetermined thrashing value, prohibiting from lending the contiguous memory.

4. The contiguous memory allocation device of claim 1, wherein the predetermined thrashing value is proportional to a memory pressure of the memory.

5. The contiguous memory allocation device of claim 1, wherein the predetermined thrashing value ranges from 1 percentage to 200 percentage.

6. The contiguous memory allocation device of claim 1, wherein the predetermined thrashing value comprises 10 percentage.

7. The contiguous memory allocation device of claim 1, wherein the processor is further configured to read the at least one command to execute following step:
calculating the page thrashing value according to a current file page number which is frequently used, a previous file page number which is frequently used, and a total file page number which is previously used.

8. The contiguous memory allocation device of claim 1, wherein the processor is further configured to read the at least one command to execute following steps:
calculating a file page number difference between a current file page number which is frequently used and a previous file page number which is frequently used; and
calculating a percentage of the file page number difference and a total file page number which is previously used to serve as the page thrashing value.

9. A contiguous memory allocation method, executed by a processor reading at least one command stored in a memory, comprising:
calculating a page thrashing value of the memory;
determining a corresponding relation between the page thrashing value and a predetermined thrashing value; and
deciding whether to lend a contiguous memory according to the corresponding relation.

10. The contiguous memory allocation method of claim 9, wherein determining the corresponding relation between the page thrashing value and the predetermined thrashing value comprises:
determining whether the page thrashing value is larger than the predetermined thrashing value;
wherein deciding whether to lend the contiguous memory according to the corresponding relation comprises:
if the page thrashing value is larger than the predetermined thrashing value, lending the contiguous memory.

11. The contiguous memory allocation method of claim 9, wherein determining the corresponding relation between the page thrashing value and the predetermined thrashing value comprises:
determining whether the page thrashing value is larger than the predetermined thrashing value;
wherein deciding whether to lend the contiguous memory according to the corresponding relation comprises:
if the page thrashing value is not larger than the predetermined thrashing value, prohibiting from lending the contiguous memory.

12. The contiguous memory allocation method of claim 9, wherein the predetermined thrashing value is proportional to a memory pressure of the memory.

13. The contiguous memory allocation method of claim 9, wherein the predetermined thrashing value ranges from 1 percentage to 200 percentage.

14. The contiguous memory allocation method of claim 9, wherein the predetermined thrashing value comprises 10 percentage.

15. The contiguous memory allocation method of claim 9, further comprising:
calculating the page thrashing value according to a current file page number which is frequently used, a previous file page number which is frequently used, and a total file page number which is previously used.

16. The contiguous memory allocation method of claim 9, further comprising:
calculating a file page number difference between a current file page number which is frequently used and a previous file page number which is frequently used; and
calculating a percentage of the file page number difference and a total file page number which is previously used to serve as the page thrashing value.
